(19) United States
(12) Patent Application Publication
(10) Pub. No.: US 2026/0205623 A1
(43) Pub. Date: Jul. 16, 2026

(54) ADAPTIVE TRANSFORM KERNEL DERIVATION IN BLOCKS APPLIED NON-CONVENTIONAL INTRA MODES

(71) Applicant: Tencent America LLC, Palo Alto, CA (US)

(72) Inventors: Biao WANG, San Jose, CA (US); Yifan WANG, Palo Alto, CA (US); Lien-Fei CHEN, Palo Alto, CA (US); Shan LIU, San Jose, CA (US); Yonguk YOON, Palo Alto, CA (US); Roman CHERNYAK, Santa Clara, CA (US); Ziyue XIANG, Palo Alto, CA (US)

(73) Assignee: Tencent America LLC, Palo Alto, CA (US)

(21) Appl. No.: 19/367,800

(22) Filed: Oct. 23, 2025

Related U.S. Application Data
(60) Provisional application No. 63/746,150, filed on Jan. 16, 2025.

(51) Int. Cl. H04N 19/593; H04N 19/11; H04N 19/136; H04N 19/172; H04N 19/176

(52) U.S. Cl. CPC H04N 19/593; H04N 19/11; H04N 19/136; H04N 19/172; H04N 19/176

(57) ABSTRACT

Some aspects of the disclosure provide a method of video decoding. In an example, a coded video bitstream is received. The coded video bitstream includes coded information of a current block in a current picture. The current block is coded by a non-conventional intra prediction mode that is in a pre-defined set of non-conventional intra prediction modes. A virtual intra prediction mode is derived according to available information associated with the non-conventional intra prediction mode. A transform kernel is selected from at least two transform kernel sets according to the virtual intra prediction mode. The current block is reconstructed based on the transform kernel.

### INCORPORATION BY REFERENCE

The present application claims the benefit of priority to U.S. Provisional Application No. 63/746,150, filed on January 16, 2025. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received. The coded video bitstream includes coded information of a current block in a current picture. The current block is coded by a non-conventional intra prediction mode that is in a pre-defined set of non-conventional intra prediction modes. A virtual intra prediction mode is derived according to available information associated with the non-conventional intra prediction mode. A transform kernel is selected from at least two transform kernel sets according to the virtual intra prediction mode. The current block is reconstructed based on the transform kernel.

Some aspects of the disclosure provide a method for video encoding. In an example, to encode a current block in a current picture by a non-conventional intra prediction mode is determined, the non-conventional intra prediction mode is in a pre-defined set of non-conventional intra prediction modes. A virtual intra prediction mode is derived according to available information associated with the non-conventional intra prediction mode. A transform kernel is selected from at least two transform kernel sets according to the virtual intra prediction mode. Based on the transform kernel, the current block is encoded into coded information in a bitstream.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a histogram of gradients in some examples.

FIG. 5 shows a flow chart outlining a decoding process according to some aspects of the disclosure.

FIG. 6 shows a flow chart outlining an encoding process according to some aspects of the disclosure.

FIG. 7 is a schematic illustration of a computer system in accordance with an aspect.

### DETAILED DESCRIPTION

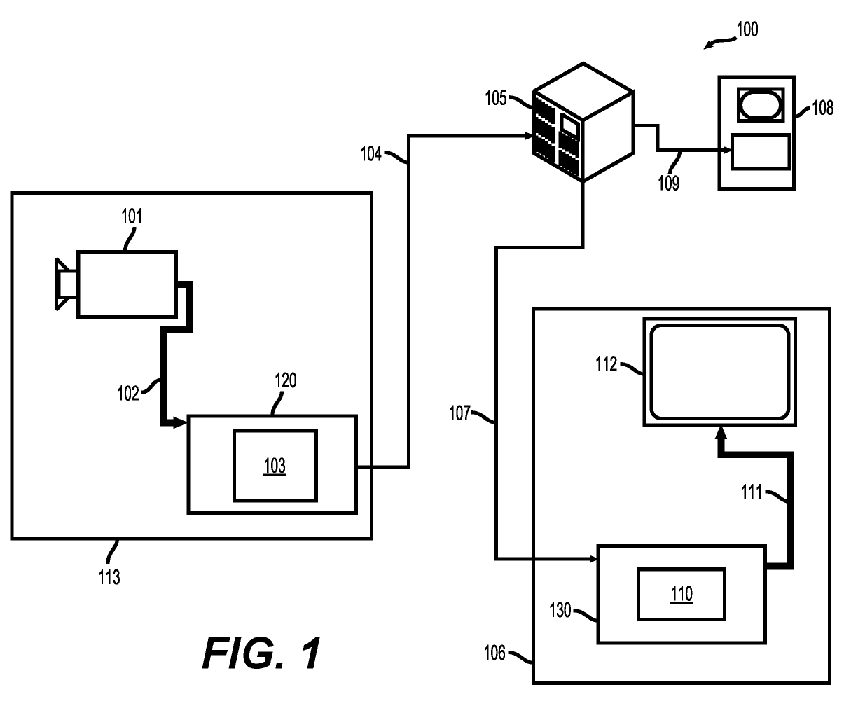

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

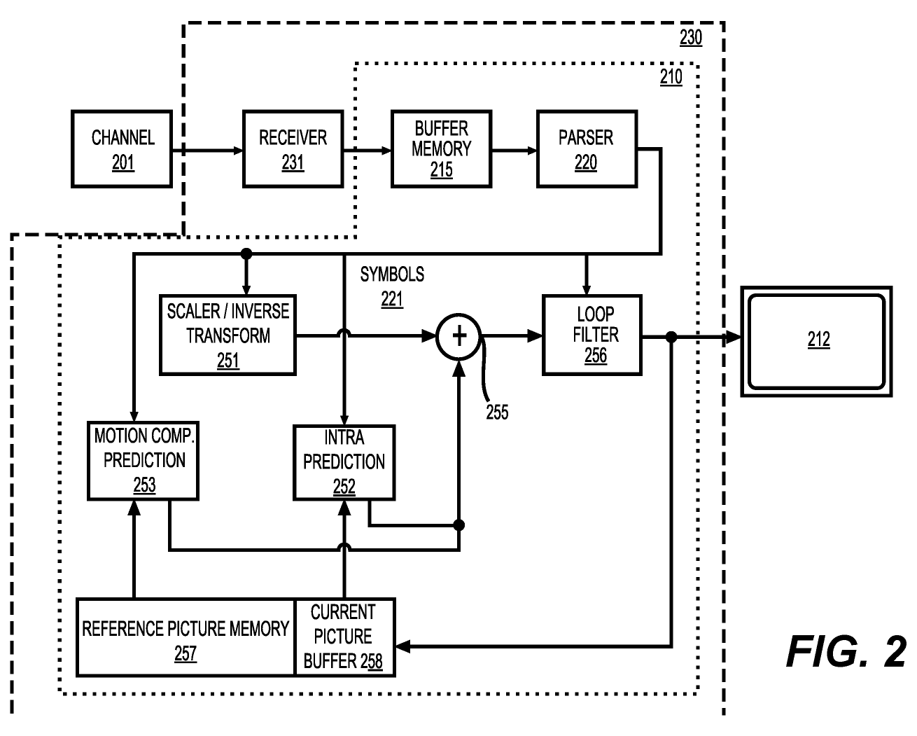

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder / parser (220) ("parser (220)" henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse / entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding / parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler / inverse transform unit (251). The scaler / inverse transform unit (251) receives a quantized transform coefficient as well as control information, including which transform to use, block size, quantization factor, quantization scaling matrices, etc. as symbol(s) (221) from the parser (220). The scaler / inverse transform unit (251) can output blocks comprising sample values, that can be input into aggregator (255).

In some cases, the output samples of the scaler / inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler / inverse transform unit (251).

In other cases, the output samples of the scaler / inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler / inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

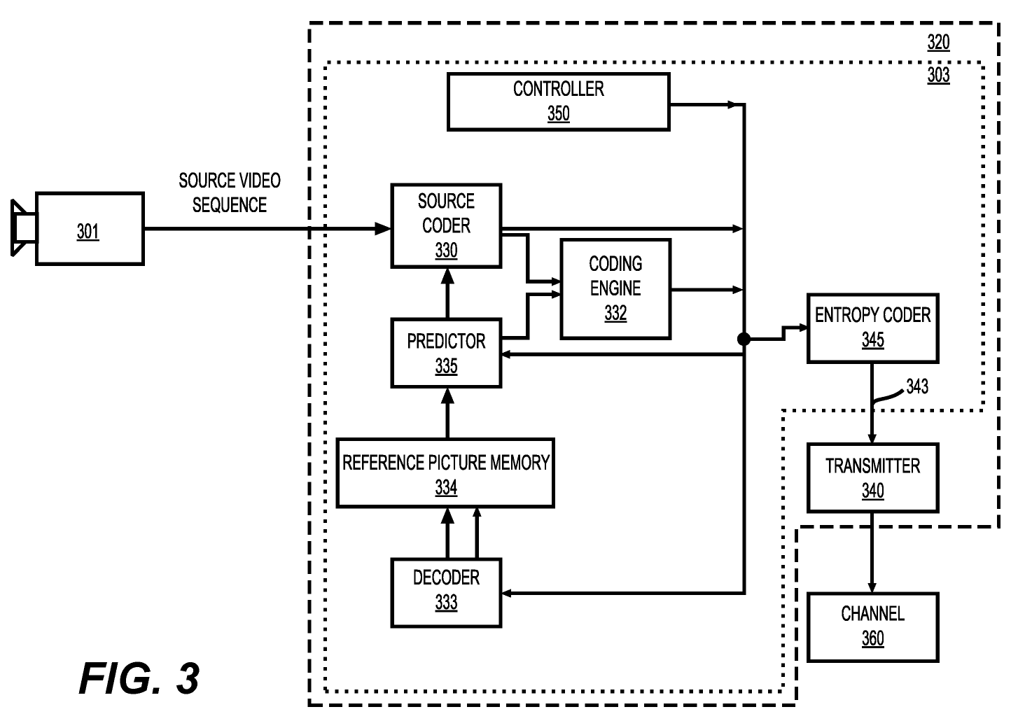

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, …), any colorspace (for example, BT.601 Y CrCB, RGB, …), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, …), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder "sees" as reference picture samples exactly the same sample values as a decoder would "see" when using prediction during decoding. This fundamental principle of reference picture synchronicity (and resulting drift, if synchronicity cannot be maintained, for example because of channel errors) is used in some related arts as well.

The operation of the "local" decoder (333) can be the same as a "remote" decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as "reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4x4, 8x8, 4x8, or 16x16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64x64 pixels, 32x32 pixels, or 16x16 pixels. In general, a CTU includes three coding tree blocks (CTBs), which are one luma CTB and two chroma CTBs. Each CTU can be recursively quadtree split into one or multiple coding units (CUs). For example, a CTU of 64x64 pixels can be split into one CU of 64x64 pixels, or 4 CUs of 32x32 pixels, or 16 CUs of 16x16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8x8 pixels, 16x16 pixels, 8x16 pixels, 16x8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for transform kernel derivation (e.g., adaptive transform kernel derivation) in blocks applied with non-conventional intra modes.

According to some aspects, image and video coding standards can use a hybrid video coding framework. A hybrid video coding framework can include various modules, such as intra prediction, inter prediction, transform, quantization and in-loop filter.

In video codec, techniques, such as transform, quantization, and the like are used to reduce redundancy and improve coding efficiency in video signals. For example, transform techniques can reduce redundancy in the video signal by decorrelation, and quantization techniques can decrease the data of the transform coefficient representation by reducing precision, for example by removing imperceptible details, and thus reducing irrelevance in the data.

In some examples, transformation decorrelates a signal by transforming the signal from the spatial domain to a transform domain (e.g., a frequency domain), using a suitable transform basis. For example, a transform is applied to the prediction residual (regardless of whether it comes from inter- or intra-picture prediction), that is, the difference between the prediction and the original input video signal. In the transform domain, the essential information typically concentrates into a small number of coefficients. At the decoder, the inverse transform can be applied to reconstruct the residual samples.

Generally, quantization is used to reduce the precision of an input value or a set of input values in order to decrease the amount of data needed to represent the values. In some examples, the quantization is typically applied to individual transformed residual samples (e.g., transform coefficients), resulting in integer coefficient levels. The quantization process is applied at the encoder. At the decoder, the corresponding process is known as inverse quantization (also referred to as dequantization), which restores the original value range without regaining the precision.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform is a kind of non-primary transform, and can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode). In some examples, a lookup table is used, and the lookup table maps LFNST sets to intra prediction modes. In some examples, an index can be signaled to select a kernel in an LFNST set (e.g., the LFNST set that maps to an intra prediction mode).

In some aspects, different types of DCT are available as candidates, and a suitable DCT can be selected to improve coding efficiency. In some examples, non-separable primary transform (NSPT) and low-frequency non-separable transform (LFNST) provide learned kernels to maximize the energy compaction ability. At the decoder side, the linear (inverse) transform kernel is applied on the de-quantized coefficient to reconstruct the spatial blocks.

Some aspects of the disclosure provide techniques for transform kernel derivation in blocks applied with non-conventional intra modes.

In some aspects, (conventional) intra prediction modes in block-based video codecs exploit spatial correlation within a single frame to predict a block from its already-decoded neighbors. The (conventional) intra prediction modes can include a DC prediction mode, a planar prediction mode, and angular prediction modes (also referred to as directional prediction modes). In an example, in the DC prediction mode, a block can be filled with an average of available boundary reference samples (e.g., reference samples at the top of the block and/or reference samples to the left of the block). In an example, in the planar prediction mode: a smoothly varying surface across the block can be generated by bilinearly interpolating between the top and left boundary references. In an example, in an angular prediction mode, pixels can be projected in a direction of the angular prediction mode to boundary of the block, and reconstructed samples of the boundary are used for prediction based on the projection. The set of angles can be codec dependent.

Various non-conventional intra modes can be used in video coding, such as spatial geometric partitioning mode (SGPM), matrix-based intra prediction (MIP), extrapolation based intra prediction (EIP), intra template matching mode (intraTMP), decoder intra mode derivation (DIMD), occurrence-based intra coding (OBIC), template-based intra mode derivation (TIMD), and the like.

For example, spatial geometric partitioning mode (SGPM) is an intra prediction variant of geometry partitioning mode (GPM). The geometry partitioning mode (GPM) is inter-coding tool that models a block as two sub-regions separated by a split line (e.g., a line with defined orientation and position) rather than using only rectangular splits. In some examples, each sub-region can use its own motion hypothesis (typically selected from merge candidates), and the encoder can signal compact geometric parameters plus the two motion candidates. The decoder can reconstruct “wedge-like” partitions and blend along the boundary to reduce artifacts.

In an aspect, the spatial geometric partitioning mode (SGPM) is an intra-prediction tool that models sharp edges within a block by splitting the block into two geometric regions and predicting each region separately. A block can be partitioned into two sub-regions by a split line defined by an orientation and position. Each sub-region is intra-predicted with its own predictor (e.g., DC, planar, or angular intra prediction modes) derived from neighboring reference samples.

In another example, matrix-based intra prediction (MIP) is an intra prediction tool that generates a prediction of a block by applying a learned, mode-dependent linear transform to boundary reference samples instead of using purely directional interpolation. For example, the top and left reference samples are vectorized, multiplied by a prediction matrix, and then reshaped to form the predicted block.

For example, the extrapolation-based intra prediction (EIP) is a video/image coding technique that predicts the pixels of a current block by extrapolating structures (edges, lines, textures) from already reconstructed neighboring samples—typically from the top and/or left reference boundaries—into the block. Instead of relying solely on fixed angular, planar, or DC modes, the extrapolation-based intra prediction (EIP) can fit a local model (e.g., linear, affine, or autoregressive) to the boundary pixels and then project that model inward to generate predictions for each pixel in the block.

In some examples, intra template matching prediction (IntraTMP) is a screen/content-oriented intra coding tool that predicts a block by copying similar content from elsewhere in the same picture, guided by matching a template. For example, the template is formed by a set of already decoded boundary samples around the current block. The encoder searches candidate positions within the same picture for blocks whose boundary around the candidate best matches this template under a distortion metric (e.g., SAD/SSD over the template samples). The best match yields a displacement vector. The predicted block is the content at that location, and can be copied into the current block position. A residual can be computed and coded in the usual transform/quantization pipeline.

In some examples, decoder intra mode derivation (DIMD) includes techniques that let the decoder to reproduce one or more intra prediction mode candidates, such as best guess mode, from already reconstructed samples, with little or no additional syntax. The decoder intra mode derivation (DIMD) can reduce signaling bits for intra modes. For example, a decoder can collect reconstructed samples along the top and left of the current prediction unit; and estimates local structure using simple, deterministic measures, such as directional gradients (e.g., horizontal vs. vertical differences), and the like. The measures can be mapped to one or more intra prediction modes. The one or more derived intra prediction modes are merged with the standard MPM list from neighbors into a candidate list. In an example, an index can be signaled to indicate the mode used to code the current block.

In some examples, occurrence-based intra coding (OBIC) includes intra-picture coding techniques that exploit the fact that some blocks—especially in screen content, computer graphics, and text overlays—contain only a small set of repeated pixel values. Instead of predicting each pixel with directional predictors and coding transform residuals, OBIC identifies the most frequently occurring sample values within a block (or region) and codes the block primarily by referencing these frequent values and the positions where they occur.

In some examples, template-based intra mode derivation (TIMD) is an intra-prediction tool to choose or refine an intra prediction mode by matching the local template of already-reconstructed pixels around the current block to similar templates in its spatial neighborhood. For example, local image structure (edges, textures, angles) repeats over short distances. By finding a nearby region whose boundary samples best resemble the current block’s boundary, the encoder can infer a likely prediction direction (mode) without exhaustively testing all intra modes, and the decoder can reproduce that decision deterministically.

In some aspects, primary (or secondary) transform kernel sets can be configured, such as trained, to compact different residual information adaptively. In some examples, a suitable transform kernel set can be determined based on the intra prediction mode. The determination of transform kernel set is either implicitly derived or explicitly signaled. Further, in an example, the transform kernel set can include multiple kernels, and an index can be signal to indicate one of the multiple kernels to use.

In some aspects, a primary or non-primary transform kernel can be derived from a plurality of transform kernel sets when a non-conventional intra prediction mode in a pre-defined set of non-conventional intra prediction modes is applied. In some examples, the pre-defined set of non-conventional intra prediction modes includes at least the spatial geometric partitioning mode (SGPM). In an example, for a block in the spatial geometric partitioning mode, the block includes two partitions, and a predictor of the block includes two predictors respectively for the two partitions, and the two predictors for the two partitions can be generated from intra prediction. The primary or non-primary transform kernel when the non-conventional intra prediction mode is applied can be selected based on a derived (e.g., similar to conventional) intra prediction mode.

In some examples, transform kernel sets are organized in buckets (also referred to as groups in some examples). For example, a first bucket, a second bucket and a third bucket can be respective defined for different prediction modes. For example, the first bucket includes a first plurality of transform kernel sets for a first plurality of prediction modes (e.g., regular intra prediction mode and the like), the second bucket includes a second plurality of transform kernel sets for a second plurality of prediction modes (e.g., inter prediction modes), and the third bucket includes a third plurality of transform kernel sets for a third plurality of prediction modes (e.g., some special prediction modes) . In some examples, a bucket of transform kernel sets is selected for a block based on prediction information of the block, and further a transform kernel set can be selected according to a derived intra prediction mode.

In some examples, the allowed pre-defined set of non-conventional intra prediction modes also includes: matrix-based intra prediction (MIP), extrapolation based intra prediction (EIP), and intra template matching mode (intraTMP). In an example, the pre-defined set of non-conventional intra prediction modes includes and only includes the above four modes (SGPM, EIP, MIP, and intraTMP).

In some examples, the allowed pre-defined set of non-conventional intra prediction modes also includes decoder intra mode derivation (DIMD), occurrence-based intra coding (OBIC), and template-based intra mode derivation (TIMD). In an example, the pre-defined set of non-conventional intra prediction modes include and only include the above four modes (SGPM, DIMD, OBIC, and TIMD)

In some examples, the allowed pre-defined set of non-conventional intra prediction modes also includes modes with prediction fusion when fusion prediction is activated. In an example, when fusion is activated in DIMD, TIMD and intraTMP, and OBIC, fusion is always applied.

In an example of DIMD, a first intra mode of 60% frequency and a second intra mode of 40% frequency are determined. According to the first intra mode, a first prediction of the current block can be generated; and according to the second intra mode, a second prediction of the current block can be generated. A fusion prediction can be generated based on a weighted sum of the first prediction and the second prediction. The weights can be determined based on the frequencies in an example.

In an example, the pre-defined set of non-conventional intra prediction modes include and only include the modes with fusion, such as SGPM, OBIC, DIMD with fusion activated, TIMD with fusion activated and intraTMP with fusion activated.

In some examples, the derived intra prediction mode for determining the kernel set (for primary or non-primary transform in a non-conventional intra prediction mode) can be referred to as virtual intra prediction mode (VIPM). In some aspects, the virtual intra prediction mode of a current block is derived using a decoder side mode derivation method on prediction samples of the current block. One of more virtual intra prediction modes derived by the decoder side mode derivation method on prediction samples of the current block are referred to as decoder side prediction derived virtual intra prediction modes (decoder side prediction derived VIPMs) in some examples. In an aspect, a histogram of gradients for all predicted samples of the current block is constructed. One or more direction indicated by the histogram of gradients can be then mapped to one or more directional intra prediction modes and the one or more directional intra prediction modes (also referred to as angular intra prediction modes) are ranked.

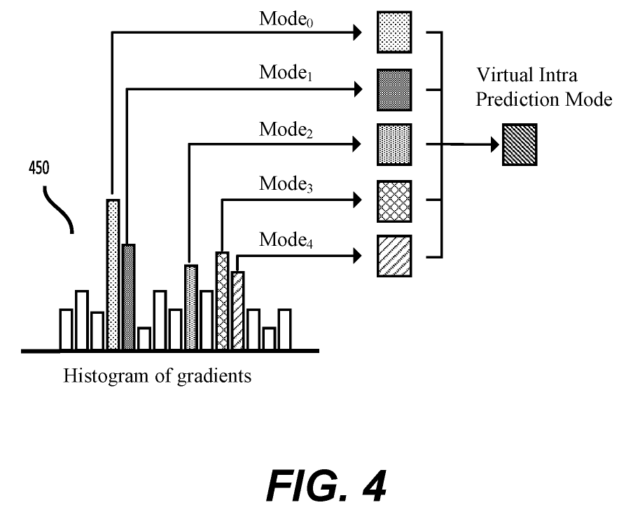

FIG. 4 shows a histogram of gradients (450) in some examples. In an example, the histogram of gradients (450) is constructed based on gradients associated with positions in a prediction block (e.g., including all predicted samples of the current block). The prediction block is suitably generated based on an intra prediction mode (e.g., one of non-conventional intra prediction modes) in the present disclosure, such as spatial geometric partitioning mode (SGPM), matrix-based intra prediction (MIP), extrapolation based intra prediction (EIP), intra template matching mode (intraTMP), decoder intra mode derivation (DIMD), occurrence-based intra coding (OBIC), template-based intra mode derivation (TIMD), and the like.

In the FIG. 4 example, the gradients can be respectively matched to (conventional) intra prediction modes. For example, five most frequent gradients are respectively matched to five intra prediction modes in FIG. 4.

In an example, the intra prediction mode that matches to the most frequent gradient is derived as a virtual intra prediction mode (VIPM), such as Mode₀ in FIG. 4. In another example, the intra prediction mode that matches to the 2^{nd} most frequent gradient is derived as the virtual intra prediction mode (VIPM), such as the Mode₁ in FIG. 4.

In some examples, the virtual intra prediction mode for a current block is derived by a decoder side mode derivation based on neighboring reconstructed samples of the current block. For example, a histogram of gradients for neighboring reconstructed samples of the current block is constructed. The directions indicated by the histogram of gradients are then mapped to one or more directional intra prediction modes (also referred to as angular intra prediction modes) and the one or more directional intra prediction modes are ranked. One of more virtual intra prediction modes derived by the decoder side mode derivation method on neighboring samples of the current block are referred to as decoder side neighbor derived virtual intra prediction modes (decoder side neighbor derived VIPMs) in some examples.

In some examples, the histogram of gradients (450) is constructed based on gradients of neighboring reconstructed samples of the current block. In the FIG. 4 example, the gradients can be respectively matched to (conventional) intra prediction modes. For example, five most frequent gradients are respectively matched to five intra prediction modes in FIG. 4. In an example, the intra prediction mode that matches to most frequent gradient is derived as a virtual intra prediction mode (VIPM), such as Mode₀ in FIG. 4. In another example, the intra prediction mode that matches to the 2^{nd} most frequent gradient is derived as the virtual intra prediction mode (VIPM), such as the Mode₁ in FIG. 4.

In some examples, when the spatial geometric partitioning mode (SGPM) is applied, the virtual intra prediction mode is derived based on the split direction of the split line for SGPM. In some examples, the virtual intra prediction mode derived based on the split direction of the split line is referred to as SGPM derived virtual intra prediction mode (SGPM derived VIPM).

In some examples, the kernel set is adaptively determined based on the intra prediction modes within regions of a SGPM coding block and the decoder side prediction derived VIPMs. For example, a decoder side mode derivation method is applied to derive two decoder side prediction derived VIPMs, such as the two most frequent intra prediction modes according to a histogram of gradients. When the current block is SGPM coding block, the current block includes two sub-regions having respective intra prediction modes. In an example, the two decoder side prediction derived VIPMs are compared with the respective intra prediction modes for the SGPM coding block. When the two decoder side prediction derived VIPMs are at least close to one of the respective intra prediction modes of the SGPM coding block, then the two decoder side prediction derived VIPMs can be used to determine the transform kernel set for the current block. Otherwise, the SGPM derived VIPM is used to determine the transform kernel set.

In some examples, when a current block is coded in the SGPM, the transform kernel set is adaptively determined based on the intra prediction modes within regions of a SGPM coding block and the decoder side prediction derived VIPMs in the above description. When a current block is coded in another non-conventional intra prediction mode in the pre-defined set, the transform kernel set is adaptively determined based on a VIPM that is decoder side prediction derived VIPM or a VIPM that is decoder side neighbor derived VIPM.

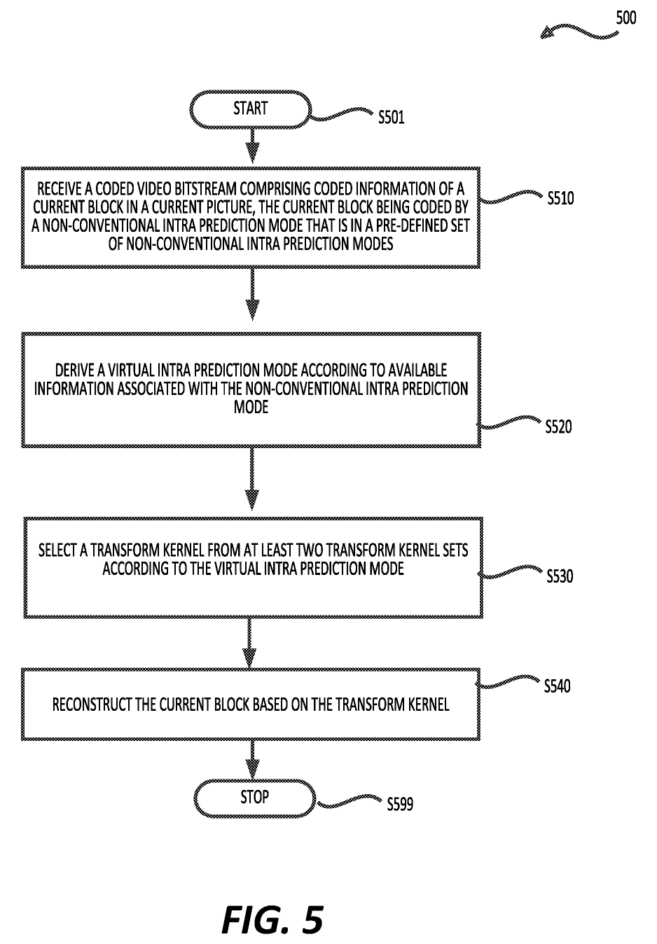

FIG. 5 shows a flow chart outlining a process (500) according to an aspect of the disclosure. The process (500) can be used in a video decoder. In various aspects, the process (500) is executed by processing circuitry, such as the processing circuitry that performs functions of the video decoder (110), the processing circuitry that performs functions of the video decoder (210), and the like. In some aspects, the process (500) is implemented in software instructions, thus when the processing circuitry executes the software instructions, the processing circuitry performs the process (500). The process starts at (S501) and proceeds to (S510).

At (S510), a coded video bitstream is received. The coded video bitstream includes coded information of a current block in a current picture. The current block is coded by a non-conventional intra prediction mode that is in a pre-defined set of non-conventional intra prediction modes. In some examples, a mapping relationship of intra prediction modes to a plurality of transform kernel sets (e.g., a bucket of transform kernel sets) is associated with the pre-defined set of non-conventional intra prediction modes.

At (S520), a virtual intra prediction mode is derived according to available information associated with the non-conventional intra prediction mode.

At (S530), a transform kernel is selected from at least two transform kernel sets according to the virtual intra prediction mode. In some examples, a plurality of transform kernel sets are mapped with intra prediction modes (e.g., DC, planar, angular intra prediction modes). The virtual intra prediction mode can correspond to an intra prediction mode. Thus, a transform kernel set can be selected from the plurality of transform kernel sets based on the virtual intra prediction mode. Further, in some examples a transform kernel can be selected from the transform kernel set based on an index.

At (S540), the current block is reconstructed based on the transform kernel.

In some aspects, the pre-defined set of non-conventional intra prediction modes comprises a spatial geometric partitioning mode (SGPM). In some examples, the pre-defined set of non-conventional intra prediction modes includes the spatial geometric partitioning mode (SGPM), a matrix-based intra prediction (MIP) mode, an extrapolation based intra prediction (EIP) mode, and an intra template matching mode (intraTMP). In some examples, the pre-defined set of non-conventional intra prediction modes comprises the spatial geometric partitioning mode (SGPM), a decoder intra mode derivation (DIMD) mode, an occurrence-based intra coding (OBIC), and a template-based intra mode derivation (TIMD).

To reconstruct the current block, in some examples, a prediction block of the current block is generated based on the non-conventional intra prediction mode. An inverse transform with the selected transform kernel can be performed on transform coefficients that are decoded from the coded video bitstream to obtain a residual block for the current block. The current block can be reconstructed by a combination of the prediction block with the residual block.

In some aspects, a fusion prediction is activated in the non-conventional intra prediction mode, and the prediction block is generated based on a weighted sum of a first prediction block and a second prediction block.

In some examples, the virtual intra prediction mode is derived from a histogram of gradients. In an example, the histogram of gradients is constructed according to predicted samples of the current block. In another example, the histogram of gradients is constructed according to neighboring reconstructed samples of the current block.

In an example, the virtual intra prediction mode is an intra prediction mode with a direction matching to a most frequent gradient in the histogram of gradients. In another example, the virtual intra prediction mode is an intra prediction mode with a direction matching to a second most frequent gradient in the histogram of gradients.

In some examples, the current block is coded in the spatial geometric partitioning mode (SGPM), then the virtual intra prediction mode is derived based on a split direction of a split line of the current block.

In some examples, the current block is coded in the spatial geometric partitioning mode (SGPM), two most frequent intra prediction modes are determined from a histogram of gradients that is constructed based on prediction samples of the current block according to the spatial geometric partitioning mode (SGPM). When the two most frequent intra prediction modes satisfy a requirement, the virtual intra prediction mode is derived based on the two most frequent intra prediction modes; and when the two most frequent intra prediction modes fail to satisfy the requirement, the virtual intra prediction mode is derived based on a split direction of a split line of the current block.

In some examples, the non-conventional intra prediction mode of the current block is not the spatial geometric partitioning mode (SGPM), the virtual intra prediction mode is derived from a histogram of gradient that is constructed according to predicted samples of the current block; or constructed according to neighboring reconstructed samples of the current block.

Then, the process proceeds to (S599) and terminates.

The process (500) can be suitably adapted. Step(s) in the process (500) can be modified and/or omitted. Additional step(s) can be added. Any suitable order of implementation can be used.

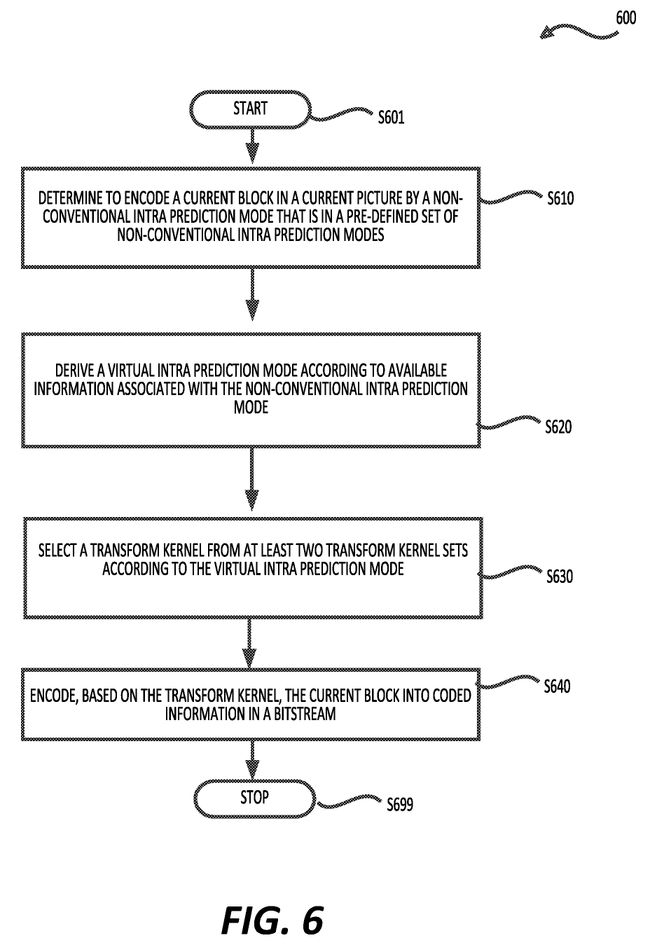

FIG. 6 shows a flow chart outlining a process (600) according to an aspect of the disclosure. The process (600) can be used in a video encoder. In various aspects, the process (600) is executed by processing circuitry, such as the processing circuitry that performs functions of the video encoder (103), the processing circuitry that performs functions of the video encoder (303), and the like. In some aspects, the process (600) is implemented in software instructions, thus when the processing circuitry executes the software instructions, the processing circuitry performs the process (600). The process starts at (S601) and proceeds to (S610).

At (S610), to encode a current block in a current picture by a non-conventional intra prediction mode is determined, the non-conventional intra prediction mode is in a pre-defined set of non-conventional intra prediction modes. In some examples, a mapping relationship of intra prediction modes to a plurality of transform kernel sets (e.g., a bucket of transform kernel sets) is associated with the pre-defined set of non-conventional intra prediction modes.

At (S620), a virtual intra prediction mode is derived according to available information associated with the non-conventional intra prediction mode.

At (S630), a transform kernel is selected from at least two transform kernel sets according to the virtual intra prediction mode. In some examples, a plurality of transform kernel sets are mapped with intra prediction modes (e.g., DC, planar, angular intra prediction modes). The virtual intra prediction mode can correspond to an intra prediction mode. Thus, a transform kernel set can be selected from the plurality of transform kernel sets based on the virtual intra prediction mode. Further, in some examples a transform kernel can be selected from the transform kernel set based on an index.

At (S640), based on the transform kernel, the current block is encoded into coded information in a bitstream.

In some aspects, the pre-defined set of non-conventional intra prediction modes comprises a spatial geometric partitioning mode (SGPM).

In some examples, the pre-defined set of non-conventional intra prediction modes comprises the spatial geometric partitioning mode (SGPM), a matrix-based intra prediction (MIP) mode, an extrapolation based intra prediction (EIP) mode, and an intra template matching mode (intraTMP).

In some examples, the pre-defined set of non-conventional intra prediction modes comprises the spatial geometric partitioning mode (SGPM), a decoder intra mode derivation (DIMD) mode, an occurrence-based intra coding (OBIC), and a template-based intra mode derivation (TIMD).

To encode, in some examples, a prediction block of the current block is generated based on the non-conventional intra prediction mode. A transform with the selected transform kernel can be performed on a residual block for the prediction block to obtain transform coefficients. The transform coefficients can be suitably processed and encoded into the coded information of the current block.

In some examples, a fusion prediction is activated in the non-conventional intra prediction mode, the prediction block is generated based on a weighted sum of a first prediction block and a second prediction block.

In some aspects, the virtual intra prediction mode is derived from a histogram of gradients. In an example, the histogram of gradients is constructed according to predicted samples of the current block. In another example, the histogram of gradients is constructed according to neighboring reconstructed samples of the current block.

In some examples, the virtual intra prediction mode includes at least one of: an intra prediction mode with a direction matching to a most frequent gradient in the histogram of gradients; and an intra prediction mode with a direction matching to a second most frequent gradient in the histogram of gradients.

In some examples, the current block is coded in the spatial geometric partitioning mode (SGPM), the virtual intra prediction mode is derived based on a split direction of a split line of the current block.

In some examples, the current block is coded in the spatial geometric partitioning mode (SGPM), two most frequent intra prediction modes are determined from a histogram of gradients that is constructed based on prediction samples of the current block according to the spatial geometric partitioning mode (SGPM). When the two most frequent intra prediction modes satisfy a requirement, the virtual intra prediction mode is derived from the two most frequent intra prediction modes; and when the two most frequent intra prediction modes fail to satisfy the requirement, the virtual intra prediction mode is derived based on a split direction of a split line of the current block.

In some examples, the non-conventional intra prediction mode of the current block is not the spatial geometric partitioning mode (SGPM), the virtual intra prediction mode is derived from a histogram of gradient that is constructed according to: predicted samples of the current block; or according to neighboring reconstructed samples of the current block.

Then, the process proceeds to (S699) and terminates.

The process (600) can be suitably adapted. Step(s) in the process (600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

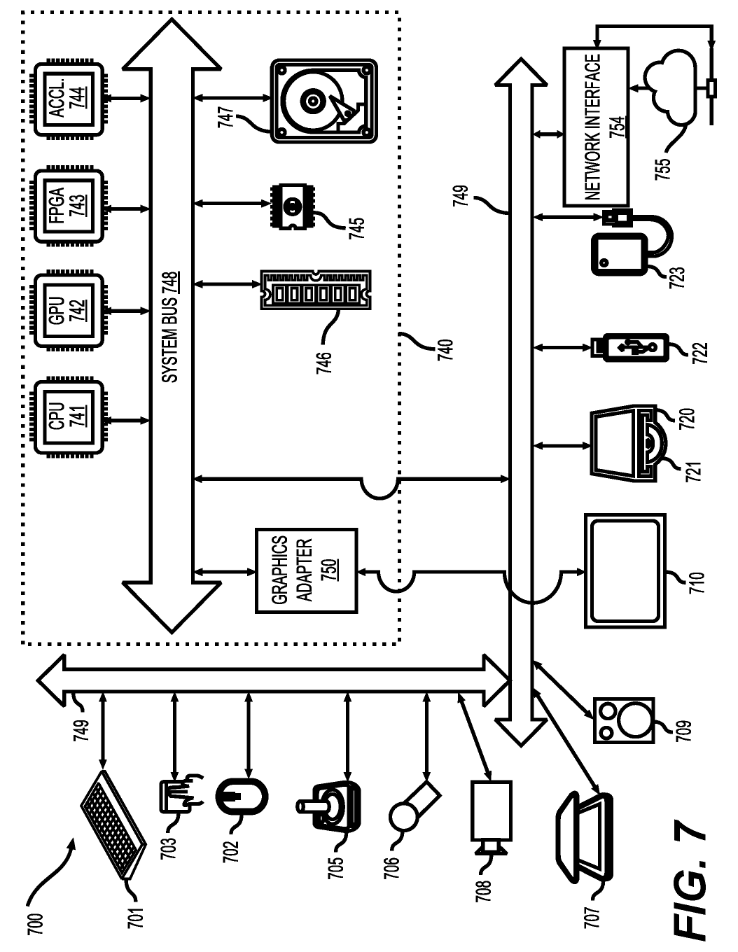

The techniques described above, can be implemented as computer software using computer-readable instructions and physically stored in one or more computer-readable media. For example, FIG. 7 shows a computer system (700) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system (700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (700).

Computer system (700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (701), mouse (702), trackpad (703), touch screen (710), data-glove (not shown), joystick (705), microphone (706), scanner (707), camera (708).

Computer system (700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (710), data-glove (not shown), or joystick (705), but there can also be tactile feedback devices that do not serve as input devices), audio output devices (such as: speakers (709), headphones (not depicted)), visual output devices (such as screens (710) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (700) can also include human accessible storage devices and their associated media such as optical media including CD/DVD ROM/RW (720) with CD/DVD or the like media (721), thumb-drive (722), removable hard drive or solid state drive (723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (700) can also include an interface (754) to one or more communication networks (755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (749) (such as, for example USB ports of the computer system (700)); others are commonly integrated into the core of the computer system (700) by attachment to a system bus as described below (for example Ethernet interface into a PC computer system or cellular network interface into a smartphone computer system). Using any of these networks, computer system (700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (740) of the computer system (700).

The core (740) can include one or more Central Processing Units (CPU) (741), Graphics Processing Units (GPU) (742), specialized programmable processing units in the form of Field Programmable Gate Areas (FPGA) (743), hardware accelerators for certain tasks (744), graphics adapters (750), and so forth. These devices, along with Read-only memory (ROM) (745), Random-access memory (746), internal mass storage such as internal non-user accessible hard drives, SSDs, and the like (747), may be connected through a system bus (748). In some computer systems, the system bus (748) can be accessible in the form of one or more physical plugs to enable extensions by additional CPUs, GPU, and the like. The peripheral devices can be attached either directly to the core’s system bus (748), or through a peripheral bus (749). In an example, the screen (710) can be connected to the graphics adapter (750). Architectures for a peripheral bus include PCI, USB, and the like.

CPUs (741), GPUs (742), FPGAs (743), and accelerators (744) can execute certain instructions that, in combination, can make up the aforementioned computer code. That computer code can be stored in ROM (745) or RAM (746). Transitional data can also be stored in RAM (746), whereas permanent data can be stored for example, in the internal mass storage (747). Fast storage and retrieve to any of the memory devices can be enabled through the use of cache memory, that can be closely associated with one or more CPU (741), GPU (742), mass storage (747), ROM (745), RAM (746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (700), and specifically the core (740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (740) that are of non-transitory nature, such as core-internal mass storage (747) or ROM (745). The software implementing various aspects of the present disclosure can be stored in such devices and executed by core (740). A computer-readable medium can include one or more memory devices or chips, according to particular needs. The software can cause the core (740) and specifically the processors therein (including CPU, GPU, FPGA, and the like) to execute particular processes or particular parts of particular processes described herein, including defining data structures stored in RAM (746) and modifying such data structures according to the processes defined by the software. In addition or as an alternative, the computer system can provide functionality as a result of logic hardwired or otherwise embodied in a circuit (for example: accelerator (744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

### The above disclosure also encompasses the features noted below. The features can be combined in various manners and are not limited to the combinations noted below.

(1). A method of video decoding, including: receiving a coded video bitstream including coded information of a current block in a current picture, the current block being coded by a non-conventional intra prediction mode that is in a pre-defined set of non-conventional intra prediction modes; deriving a virtual intra prediction mode according to available information associated with the non-conventional intra prediction mode; selecting a transform kernel from at least two transform kernel sets according to the virtual intra prediction mode; and reconstructing the current block based on the transform kernel.

(2). The method of feature (1), in which the pre-defined set of non-conventional intra prediction modes includes a spatial geometric partitioning mode (SGPM).

(3). The method of any of features (1) to (2), in which the pre-defined set of non-conventional intra prediction modes includes the spatial geometric partitioning mode (SGPM), a matrix-based intra prediction (MIP) mode, an extrapolation based intra prediction (EIP) mode, and an intra template matching mode (intraTMP).

(4). The method of any of features (1) to (3), in which the pre-defined set of non-conventional intra prediction modes includes the spatial geometric partitioning mode (SGPM), a decoder intra mode derivation (DIMD) mode, an occurrence-based intra coding (OBIC), and a template-based intra mode derivation (TIMD).

(5). The method of any of features (1) to (4), in which the reconstructing the current block includes: generating a prediction block of the current block based on the non-conventional intra prediction mode; performing an inverse transform with the selected transform kernel on transform coefficients that are decoded from the coded video bitstream to obtain a residual block for the current block; and reconstructing the current block by a combination of the prediction block with the residual block.

(6). The method of any of features (1) to (5), in which a fusion prediction is activated in the non-conventional intra prediction mode, and the generating the prediction block includes: generating the prediction block based on a weighted sum of a first prediction block and a second prediction block.

(7). The method of any of features (1) to (6), in which the deriving the virtual intra prediction mode includes: deriving the virtual intra prediction mode from a histogram of gradients.

(8). The method of any of features (1) to (7), in which the histogram of gradients is constructed according to: predicted samples of the current block; or neighboring reconstructed samples of the current block.

(9). The method of any of features (1) to (8), in which the virtual intra prediction mode includes at least one of: an intra prediction mode with a direction matching to a most frequent gradient in the histogram of gradients; and an intra prediction mode with a direction matching to a second most frequent gradient in the histogram of gradients.

(10). The method of any of features (1) to (9), in which the current block is coded in the spatial geometric partitioning mode (SGPM), the deriving the virtual intra prediction mode includes: deriving the virtual intra prediction mode based on a split direction of a split line of the current block.

(11). The method of any of features (1) to (10), in which the current block is coded in the spatial geometric partitioning mode (SGPM), the deriving the virtual intra prediction mode includes: determining two most frequent intra prediction modes from a histogram of gradients that is constructed based on prediction samples of the current block according to the spatial geometric partitioning mode (SGPM); deriving the virtual intra prediction mode from the two most frequent intra prediction modes when the two most frequent intra prediction modes satisfy a requirement; and deriving the virtual intra prediction mode based on a split direction of a split line of the current block when the two most frequent intra prediction modes fail to satisfy the requirement.

(12). The method of any of features (1) to (11), in which the non-conventional intra prediction mode of the current block is not the spatial geometric partitioning mode (SGPM), the deriving the virtual intra prediction mode includes: deriving the virtual intra prediction mode from a histogram of gradient that is constructed according to: predicted samples of the current block; or neighboring reconstructed samples of the current block.

(13). A method of video encoding, including: determining to encode a current block in a current picture by a non-conventional intra prediction mode that is in a pre-defined set of non-conventional intra prediction modes; deriving a virtual intra prediction mode according to available information associated with the non-conventional intra prediction mode; selecting a transform kernel from at least two transform kernel sets according to the virtual intra prediction mode; and encoding, based on the transform kernel, the current block into coded information in a bitstream.

(14). The method of feature (13), in which the pre-defined set of non-conventional intra prediction modes includes a spatial geometric partitioning mode (SGPM).

(15). The method of any of features (13) to (14), in which the pre-defined set of non-conventional intra prediction modes includes the spatial geometric partitioning mode (SGPM), a matrix-based intra prediction (MIP) mode, an extrapolation based intra prediction (EIP) mode, and an intra template matching mode (intraTMP).

(16). The method of any of features (13) to (15), in which the pre-defined set of non-conventional intra prediction modes includes the spatial geometric partitioning mode (SGPM), a decoder intra mode derivation (DIMD) mode, an occurrence-based intra coding (OBIC), and a template-based intra mode derivation (TIMD).

(17). The method of any of features (13) to (16), in which the encoding includes: generating a prediction block of the current block based on the non-conventional intra prediction mode; performing a transform with the selected transform kernel on a residual block for the prediction block to obtain transform coefficients; and encoding based on the transform coefficients.

(18). The method of any of features (13) to (17), in which a fusion prediction is activated in the non-conventional intra prediction mode, and the generating the prediction block includes: generating the prediction block based on a weighted sum of a first prediction block and a second prediction block.

(19). The method of any of features (13) to (18), in which the deriving the virtual intra prediction mode includes: deriving the virtual intra prediction mode from a histogram of gradients.

(20). The method of any of features (13) to (19), in which the histogram of gradients is constructed according to: predicted samples of the current block; or neighboring reconstructed samples of the current block.

(21). The method of any of features (13) to (20), in which the virtual intra prediction mode includes at least one of: an intra prediction mode with a direction matching to a most frequent gradient in the histogram of gradients; and an intra prediction mode with a direction matching to a second most frequent gradient in the histogram of gradients.

(22). The method of any of features (13) to (21), in which the current block is coded in the spatial geometric partitioning mode (SGPM), the deriving the virtual intra prediction mode includes: deriving the virtual intra prediction mode based on a split direction of a split line of the current block.

(23). The method of any of features (13) to (22), in which the current block is coded in the spatial geometric partitioning mode (SGPM), the deriving the virtual intra prediction mode includes: determining two most frequent intra prediction modes from a histogram of gradients that is constructed based on prediction samples of the current block according to the spatial geometric partitioning mode (SGPM); deriving the virtual intra prediction mode from the two most frequent intra prediction modes when the two most frequent intra prediction modes satisfy a requirement; and deriving the virtual intra prediction mode based on a split direction of a split line of the current block when the two most frequent intra prediction modes fail to satisfy the requirement.

(24). The method of any of features (13) to (23), in which the non-conventional intra prediction mode of the current block is not the spatial geometric partitioning mode (SGPM), the deriving the virtual intra prediction mode includes: deriving the virtual intra prediction mode from a histogram of gradient that is constructed according to: predicted samples of the current block; or neighboring reconstructed samples of the current block.

(25). A non-transitory computer-readable storage medium storing instructions which when executed by a processor cause the processor to perform an encoding method, the encoding method including: determining to encode a current block in a current picture by a non-conventional intra prediction mode that is in a pre-defined set of non-conventional intra prediction modes; deriving a virtual intra prediction mode according to available information associated with the non-conventional intra prediction mode; selecting a transform kernel from at least two transform kernel sets according to the virtual intra prediction mode; encoding, based on the transform kernel, the current block into coded information in a bitstream; and transmitting the bitstream.

(26). An apparatus for video decoding, including processing circuitry that is configured to perform the method of any of features (1) to (12).

(27). An apparatus for video encoding, including processing circuitry that is configured to perform the method of any of features (13) to (24).

(28). A non-transitory computer-readable storage medium storing instructions which when executed by at least one processor cause the at least one processor to perform the method of any of features (1) to (25).

What is claimed is:

1. A method of video decoding, comprising:
receiving a coded video bitstream comprising coded information of a current block in a current picture, the current block being coded by a non-conventional intra prediction mode that is in a pre-defined set of non-conventional intra prediction modes;
deriving a virtual intra prediction mode according to available information associated with the non-conventional intra prediction mode;
selecting a transform kernel from at least two transform kernel sets according to the virtual intra prediction mode; and
reconstructing the current block based on the transform kernel.

2. The method of claim 1, wherein the pre-defined set of non-conventional intra prediction modes comprises a spatial geometric partitioning mode (SGPM).

3. The method of claim 2, wherein the pre-defined set of non-conventional intra prediction modes comprises the spatial geometric partitioning mode (SGPM), a matrix-based intra prediction (MIP) mode, an extrapolation based intra prediction (EIP) mode, and an intra template matching mode (intraTMP).

4. The method of claim 2, wherein the pre-defined set of non-conventional intra prediction modes comprises the spatial geometric partitioning mode (SGPM), a decoder intra mode derivation (DIMD) mode, an occurrence-based intra coding (OBIC), and a template-based intra mode derivation (TIMD).

5. The method of claim 2, wherein the reconstructing the current block comprises:
generating a prediction block of the current block based on the non-conventional intra prediction mode;
performing an inverse transform with the selected transform kernel on transform coefficients that are decoded from the coded video bitstream to obtain a residual block for the current block; and
reconstructing the current block by a combination of the prediction block with the residual block.

6. The method of claim 5, wherein a fusion prediction is activated in the non-conventional intra prediction mode, and the generating the prediction block comprises:
generating the prediction block based on a weighted sum of a first prediction block and a second prediction block.

7. The method of claim 1, wherein the deriving the virtual intra prediction mode comprises:
deriving the virtual intra prediction mode from a histogram of gradients.

8. The method of claim 7, wherein the histogram of gradients is constructed according to:
predicted samples of the current block; or
neighboring reconstructed samples of the current block.

9. The method of claim 7, wherein the virtual intra prediction mode comprises at least one of:
an intra prediction mode with a direction matching to a most frequent gradient in the histogram of gradients; and
an intra prediction mode with a direction matching to a second most frequent gradient in the histogram of gradients.

10. The method of claim 2, wherein the current block is coded in the spatial geometric partitioning mode (SGPM), the deriving the virtual intra prediction mode comprises:
deriving the virtual intra prediction mode based on a split direction of a split line of the current block.

11. The method of claim 2, wherein the current block is coded in the spatial geometric partitioning mode (SGPM), the deriving the virtual intra prediction mode comprises:
determining two most frequent intra prediction modes from a histogram of gradients that is constructed based on prediction samples of the current block according to the spatial geometric partitioning mode (SGPM);
deriving the virtual intra prediction mode from the two most frequent intra prediction modes when the two most frequent intra prediction modes satisfy a requirement; and
deriving the virtual intra prediction mode based on a split direction of a split line of the current block when the two most frequent intra prediction modes fail to satisfy the requirement.

12. The method of claim 2, wherein the non-conventional intra prediction mode of the current block is not the spatial geometric partitioning mode (SGPM), the deriving the virtual intra prediction mode comprises:
deriving the virtual intra prediction mode from a histogram of gradient that is constructed according to:
predicted samples of the current block; or
neighboring reconstructed samples of the current block.

13. A method of video encoding, comprising:
determining to encode a current block in a current picture by a non-conventional intra prediction mode that is in a pre-defined set of non-conventional intra prediction modes;
deriving a virtual intra prediction mode according to available information associated with the non-conventional intra prediction mode;
selecting a transform kernel from at least two transform kernel sets according to the virtual intra prediction mode; and
encoding, based on the transform kernel, the current block into coded information in a bitstream.

14. The method of claim 13, wherein the pre-defined set of non-conventional intra prediction modes comprises a spatial geometric partitioning mode (SGPM).

15. The method of claim 14, wherein the pre-defined set of non-conventional intra prediction modes comprises the spatial geometric partitioning mode (SGPM), a matrix-based intra prediction (MIP) mode, an extrapolation based intra prediction (EIP) mode, and an intra template matching mode (intraTMP).

16. The method of claim 14, wherein the pre-defined set of non-conventional intra prediction modes comprises the spatial geometric partitioning mode (SGPM), a decoder intra mode derivation (DIMD) mode, an occurrence-based intra coding (OBIC), and a template-based intra mode derivation (TIMD).

17. The method of claim 14, wherein the encoding comprises:
generating a prediction block of the current block based on the non-conventional intra prediction mode;
performing a transform with the selected transform kernel on a residual block for the prediction block to obtain transform coefficients; and
encoding based on the transform coefficients.

18. The method of claim 17, wherein a fusion prediction is activated in the non-conventional intra prediction mode, and the generating the prediction block comprises:
generating the prediction block based on a weighted sum of a first prediction block and a second prediction block.

19. The method of claim 13, wherein the deriving the virtual intra prediction mode comprises:
deriving the virtual intra prediction mode from a histogram of gradients.

20. A non-transitory computer-readable storage medium storing instructions which when executed by a processor cause the processor to perform an encoding method, the encoding method comprising:
determining to encode a current block in a current picture by a non-conventional intra prediction mode that is in a pre-defined set of non-conventional intra prediction modes;
deriving a virtual intra prediction mode according to available information associated with the non-conventional intra prediction mode;
selecting a transform kernel from at least two transform kernel sets according to the virtual intra prediction mode;
encoding, based on the transform kernel, the current block into coded information in a bitstream; and
transmitting the bitstream.
